(19) United States
(12) Patent Application Publication
(10) Pub. No.: US 2026/0300003 A1
(43) Pub. Date: Oct. 1, 2026

(54) INFORMATION PROCESSING APPARATUS, INFORMATION PROCESSING METHOD, AND COMPUTER PROGRAM PRODUCT

(71) Applicant: Panasonic Intellectual Property Management Co., Ltd., Osaka (JP)

(72) Inventor: Duyhinh NGUYEN, Singapore (SG)

(21) Appl. No.: 19/539,767

(22) Filed: Feb. 13, 2026

(30) Foreign Application Priority Data
Mar. 31, 2025 (JP) 2025-059206

(51) Int. Cl. G06F 9/48

(52) U.S. Cl. CPC G06F 9/4881

(57) ABSTRACT

An information processing apparatus includes a memory, and a hardware processor coupled to the memory and configured to: receive call task execution request information including call task information and a specific position, the call task information indicating a call task in which a mobile object is called to the specific position; specify, as a call execution target mobile object of an execution target of the call task, the mobile object identified by mobile object identification information corresponding to task assignment information indicating absence of task assignment in mobile object management information in which the mobile object identification information and the task assignment information are at least associated with each other, when receiving the call task execution request information; and transmit, to the call execution target mobile object, call task execution instruction information indicating a movement instruction to the specific position included in the call task execution request information.

### CROSS-REFERENCE TO RELATED APPLICATIONS

This application is based upon and claims the benefit of priority from Japanese Patent Application No. 2025-059206, filed on Mar. 31, 2025, the entire contents of which are incorporated herein by reference.

### FIELD

Embodiments described herein relate generally to an information processing apparatus, an information processing method, and a computer program product.

### BACKGROUND

A system that performs group control of movement of a plurality of mobile objects such as robots that can move in a real space is known.

However, in the related art, a new task is assigned to a mobile object regardless of whether or not the mobile object is executing a task, and effective management of the mobile object may not be performed.

A related technology is described in JP 2023-81320 A.

The present invention has been made in view of the above, and an object thereof is to provide an information processing apparatus, an information processing method, and an information processing program capable of effectively managing a mobile object.

### SUMMARY

An information processing apparatus according to an embodiment includes a memory, and a hardware processor coupled to the memory and configured to: receive call task execution request information including call task information and a specific position, the call task information indicating a call task in which a mobile object is called to the specific position; specify, as a call execution target mobile object of an execution target of the call task, the mobile object identified by mobile object identification information corresponding to task assignment information indicating absence of task assignment in mobile object management information in which the mobile object identification information and the task assignment information are at least associated with each other, when receiving the call task execution request information; and transmit, to the call execution target mobile object, call task execution instruction information indicating a movement instruction to the specific position included in the call task execution request information.

### BRIEF DESCRIPTION OF THE DRAWINGS

FIG. 1 is an explanatory diagram illustrating an example of a mobile object management system;

FIG. 2 is a functional block diagram of an example of a mobile object management system;

FIG. 3 is a schematic diagram of an example of a data configuration of mobile object information;

FIG. 4A is an explanatory diagram of an example of a mobile object that executes a task;

FIG. 4B is an explanatory diagram of an example of a mobile object that executes a task;

FIG. 5A is a schematic diagram of an example of a data configuration of a task management DB;

FIG. 5B is a schematic diagram of an example of a data configuration of a mobile object management DB;

FIG. 6 is a sequence diagram illustrating an example of a flow of information processing executed in the mobile object management system;

FIG. 7 is a flowchart illustrating an example of a flow of information processing executed by the information processing apparatus; and

FIG. 8 is a hardware configuration diagram.

### DETAILED DESCRIPTION

Hereinafter, embodiments of an information processing apparatus, an information processing method, and an information processing program will be described in detail with reference to the accompanying drawings.

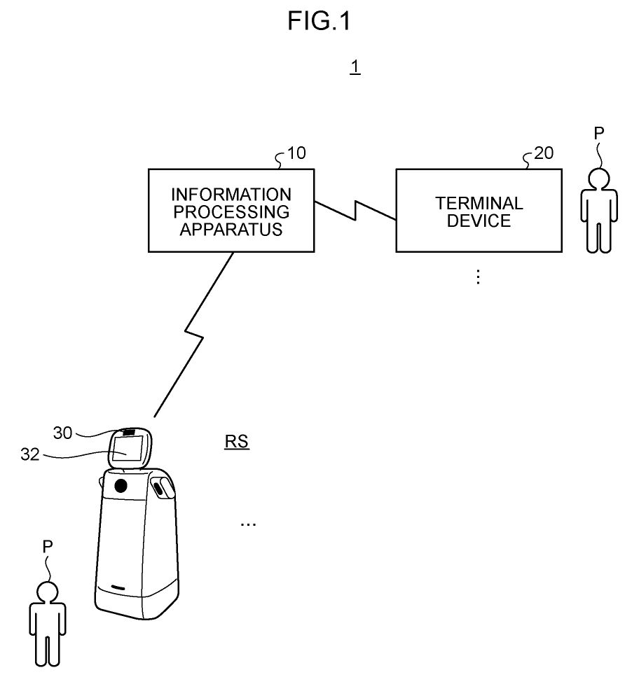

FIG. 1 is an explanatory diagram illustrating an example of a mobile object management system 1 of the present embodiment.

The mobile object management system 1 includes an information processing apparatus 10, one or a plurality of terminal devices 20, and a plurality of mobile objects 30. The information processing apparatus 10 and the terminal device 20 are communicably connected to each other in a wireless or wired manner via a network or the like. The information processing apparatus 10 and the mobile object 30 are connected to be able to perform wireless communication via a network or the like.

The information processing apparatus 10 is an information processing apparatus that manages a plurality of mobile objects 30.

The terminal device 20 is an information processing apparatus operated by a user P. The terminal device 20 is, for example, a smartphone, a tablet terminal, or the like.

The mobile object 30 is an autonomously movable object. The mobile object 30 is, for example, a vehicle that autonomously moves, a robot that has a moving function and autonomously moves, or the like. In the present embodiment, a mode in which the mobile object 30 is a robot having a moving function and autonomously moving will be described as an example.

The mobile object 30 moves in a predetermined area in a real space RS. The predetermined area is, for example, a specific area in the real space RS, a specific building in the real space RS, or the like. The building is, for example, a building such as a hospital, a store, or a company, but is not limited thereto.

The mobile object 30 executes a task assigned by the information processing apparatus 10.

The task type of the task executed by the mobile object 30 includes a call task, a delivery task, a sequential delivery task, a return task, and the like.

The call task is a task in which the mobile object 30 is called from the current position to a specific position. The call task execution request information indicating the execution request of the call task is input by an operation instruction of the terminal device 20 by the user P.

The delivery task is a task of delivering a load to a destination. The delivery task execution request information indicating the execution request of the delivery task is input by an operation instruction of a user interface (UI) unit 32 of the mobile object 30 by the user P.

The sequential delivery task is a task of delivering a load through a plurality of destinations in order. The sequential delivery request information indicating the execution request of the sequential delivery task is input by an operation instruction of the terminal device 20 by the user P.

The return task is a task of returning to a predetermined standby position where a charger or the like is installed. The standby position may be referred to as a dock.

Each of the plurality of mobile objects 30 included in the mobile object management system 1 is configured to be capable of executing a task assigned by the information processing apparatus 10.

Next, a functional configuration of the mobile object management system 1 will be described.

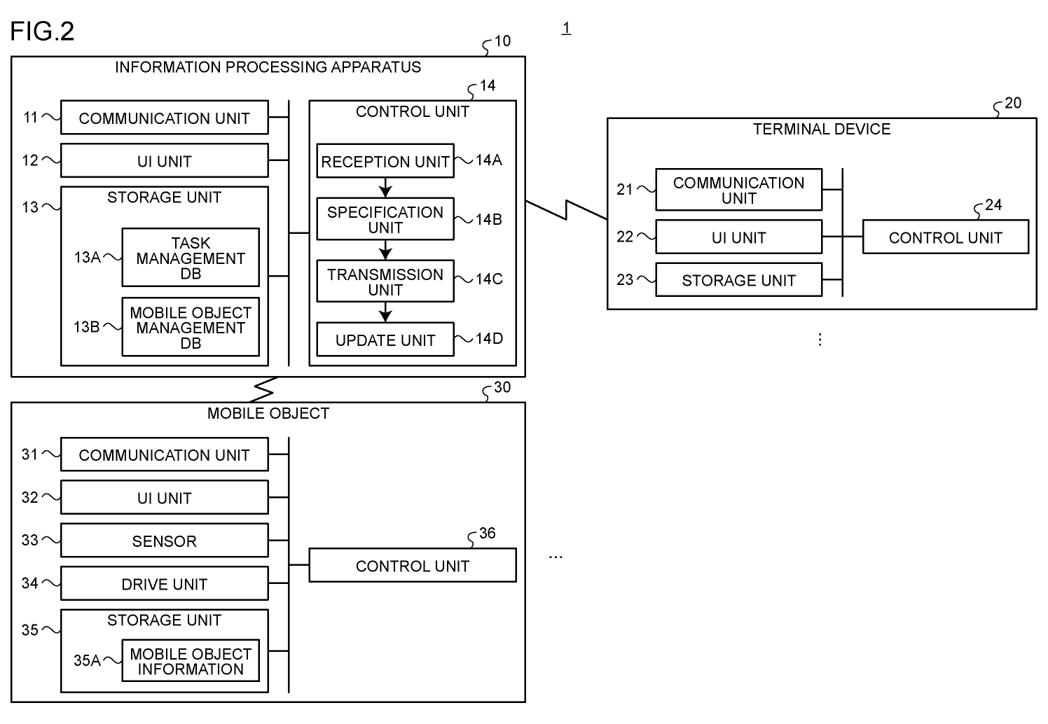

FIG. 2 is a functional block diagram of an example of the mobile object management system 1.

The mobile object management system 1 includes an information processing apparatus 10, a terminal device 20, and a mobile object 30.

First, the mobile object 30 will be described.

The mobile object 30 includes a communication unit 31, a UI unit 32, a sensor 33, a drive unit 34, a storage unit 35, and a control unit 36. The communication unit 31, the UI unit 32, the sensor 33, the drive unit 34, the storage unit 35, and the control unit 36 are communicably connected via a bus or the like.

The communication unit 31 is a communication interface that communicates with the information processing apparatus 10 or the like via a network or the like. The UI unit 32 has an input function of receiving various operations by the user P and an output function of outputting various types of information. The input function is, for example, a pointing device such as a keyboard and a mouse, an input button, a microphone, or the like. The output function is a display that displays various types of information, a speaker that outputs various types of sound, or the like. In the present embodiment, a mode in which the UI unit 32 is a touch panel integrally configured with an input function and an output function will be described as an example.

The sensor 33 is a sensor that observes the environment of the mobile object 30 and acquires observation information. The observation information includes at least position information of the mobile object 30, door open/close state information of a door provided in the mobile object 30, remaining battery capacity information, and a communication state.

The position information of the mobile object 30 may be a relative position or an absolute position. In the present embodiment, a mode in which position information of the mobile object 30 is an absolute position represented by latitude and longitude will be described as an example. The door open/close state information is information indicating whether a door provided in the mobile object 30 is in a door open state or a door closed state. The remaining battery capacity information is information indicating the remaining battery capacity which is the driving power of the mobile object 30. The communication state is information indicating a communication state between the mobile object 30 and the information processing apparatus 10.

The sensor 33 includes, for example, a position sensor (global navigation satellite system (GNSS), global positioning system (GPS)), a door open/close detection sensor, a remaining battery capacity sensor, a communication state detection sensor, and the like.

Furthermore, the observation information may include a captured image around the mobile object 30, a distance to an object around the mobile object 30, and the like. In this case, the sensor 33 further includes an imaging device that obtains a captured image by imaging, a distance sensor, and the like. The distance sensor is, for example, a millimeter wave radar, a laser sensor, a distance image sensor, or the like. The captured image is digital image data defining a pixel value for each pixel, a depth map defining a distance from the sensor 33 for each pixel, or the like. The laser sensor is, for example, a two-dimensional laser imaging detection and ranging (LiDAR) sensor or a three-dimensional LiDAR sensor installed in parallel with a horizontal plane.

The drive unit 34 is a device that is mounted on the mobile object 30 and performs driving related to the movement of the mobile object 30. The drive unit 34 is, for example, an engine, a motor, a wheel, or the like. The drive unit 34 is driven under the control of the control unit 36. For example, the control unit 36 determines the surrounding situation on the basis of the information or the like obtained from the sensor 33, and controls the drive unit 34 of the mobile object 30 to autonomously move toward the destination position received from the information processing apparatus 10 on the basis of the route information received from the information processing apparatus 10.

The storage unit 35 stores various data. The storage unit 35 is, for example, a semiconductor memory element such as a random access memory (RAM) or a flash memory, a hard disk, an optical disk, or the like.

In the present embodiment, the storage unit 35 stores mobile object information 35A.

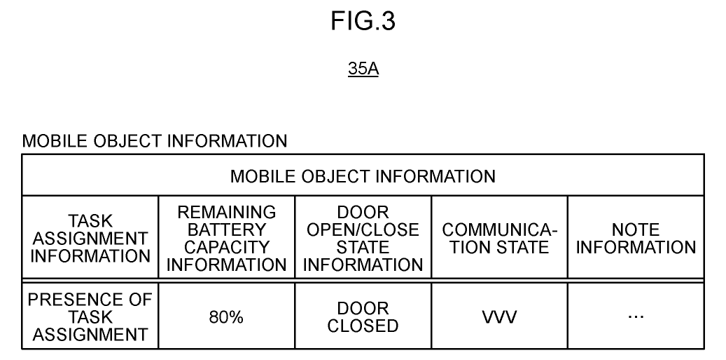

FIG. 3 is a schematic diagram of an example of a data configuration of the mobile object information 35A. The mobile object information 35A is information related to the mobile object 30 including the storage unit 35 in which the mobile object information 35A is stored. Note that the actual structure of the mobile object information 35A may be more complicated, but portions not directly related to the present invention are illustrated in a simplified manner from the actual structure.

For example, the mobile object information 35A includes task assignment information, remaining battery capacity information, door open/close state information, a communication state, and note information.

The task assignment information is information indicating an assignment status of a task. Specifically, the task assignment information is information indicating presence or absence of task assignment. The presence of task assignment indicates that a task has been assigned to the mobile object 30. The absence of task assignment indicates a state in which no task is assigned to the mobile object 30. The presence of task assignment may be expressed as "Reserved". The absence of task assignment may be expressed as "Free".

The note information is other information related to the mobile object 30. For example, the note information includes login state information indicating whether or not the user is touching (logging in) the UI unit 32 of the mobile object 30, and the like.

The mobile object information 35A is updated by the control unit 36 of the mobile object 30 (details will be described below). In addition, every time the login state information in the mobile object information 35A is changed, the control unit 36 transmits the mobile object ID of the mobile object 30 and the login state information to the information processing apparatus 10.

Returning to FIG. 2, the description will be continued.

The control unit 36 executes various processes in the mobile object 30. The control unit 36 is realized by one or a plurality of processors. For example, the control unit 36 may be realized by causing a processor such as a central processing unit (CPU) to execute a program, that is, by software. Furthermore, the control unit 36 may be realized by a processor such as a dedicated IC, that is, hardware. The control unit 36 may be realized by using software and hardware in combination.

Every time new observation information is obtained by the sensor 33, the control unit 36 updates the mobile object information 35A, and sequentially transmits the mobile object ID of the mobile object 30 and the observation information to the information processing apparatus 10.

In addition, the control unit 36 executes the task of the task type assigned by the information processing apparatus 10 according to the task execution instruction information such as the call task execution instruction information, the delivery task execution instruction information, the return task execution instruction information, and the sequential delivery task execution instruction information received from the information processing apparatus 10.

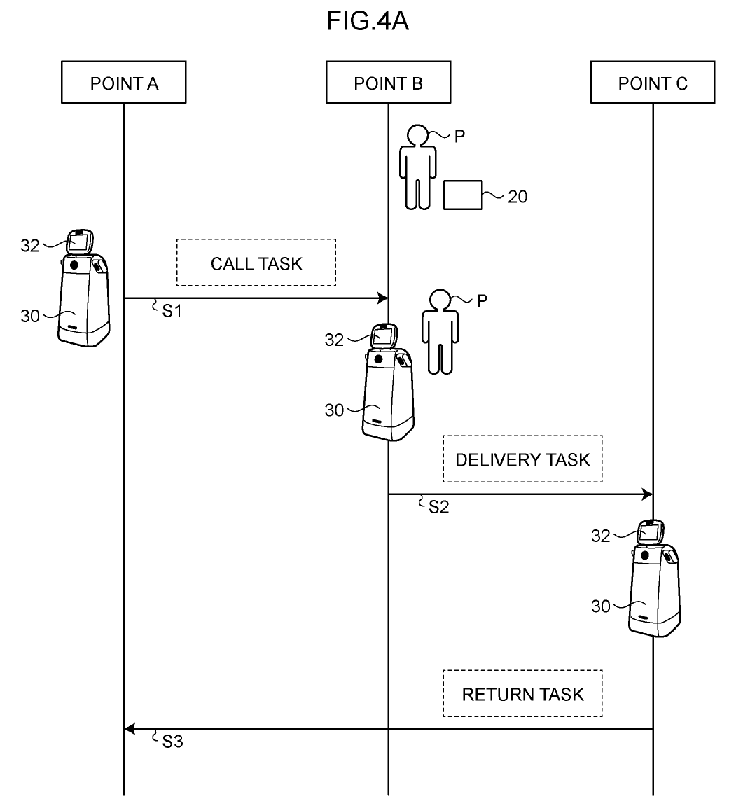

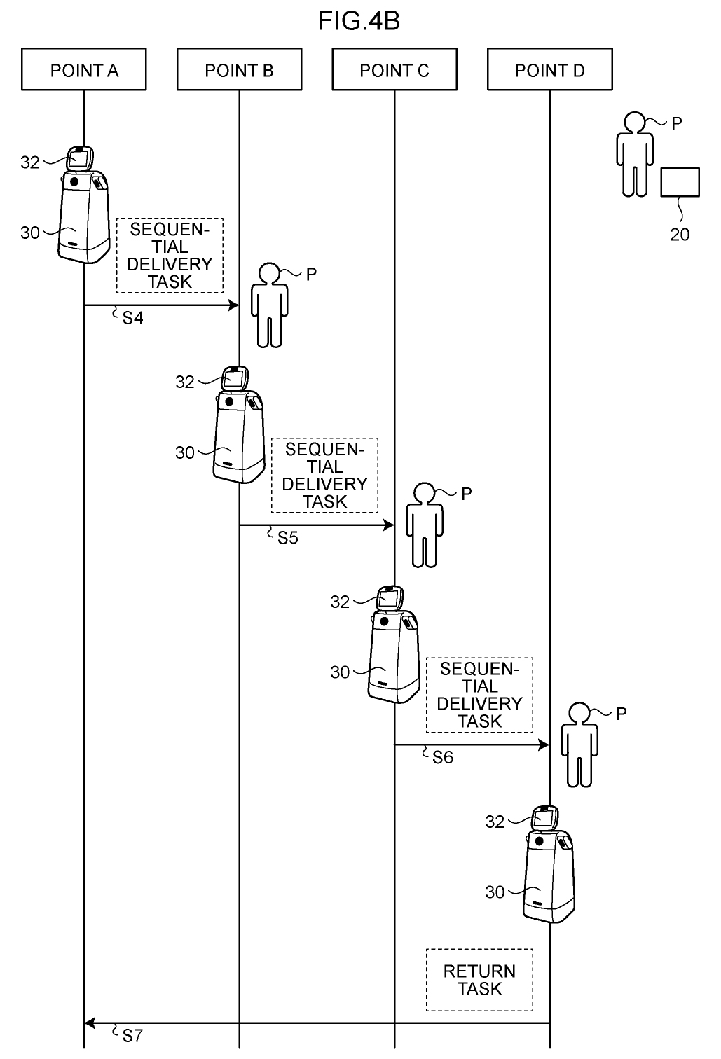

FIG. 4A is an explanatory diagram of an example of the mobile object 30 that executes the call task, the delivery task, and the return task. In FIG. 4A, detailed communication between the mobile object 30 and the information processing apparatus 10 is omitted, and an outline of a task will be described.

For example, it is assumed that the call task execution request information is input by the operation instruction of the terminal device 20 by the user P, and the call task in which the mobile object 30 existing at the point A, which is the standby position, is called to the point B is executed. It is assumed that the input of the call task execution request information can be input only by an operation instruction of the terminal device 20 by the user P and cannot be input from the UI unit 32 of the mobile object 30. In this case, the mobile object 30 moves to the point B by executing the call task (step S1).

Then, a scene where the user P inputs the delivery task execution request information by operating the UI unit 32 on the mobile object 30 that has reached the point B is assumed. Note that it is assumed that the input of the delivery task execution request information can be input only by an operation instruction of the UI unit 32 of the mobile object 30 by the user P and cannot be input from the terminal device 20. In this case, the mobile object 30 that has reached the point B executes the delivery task of delivering the load to the point C, which is the destination indicated by the delivery task execution request information (step S2).

Then, in a case where there is no next task, the mobile object 30 executes a return task (step S3) and returns to the point A.

FIG. 4B is an explanatory diagram of an example of the mobile object 30 that executes the sequential delivery task and the return task. In FIG. 4B, detailed communication between the mobile object 30 and the information processing apparatus 10 will be omitted, and an outline of a task will be described.

For example, a scene is assumed in which the sequential delivery task execution request information is input according to the operation instruction of the terminal device 20 by the user P, the sequential delivery task execution request information for sequentially delivering the loads from the point A to the point B, the point C, and the point D in this order is input, and the mobile object 30 existing at the point A which is the standby position executes the sequential delivery task. In this case, the mobile object 30 executes the sequential delivery task of moving to the first point B indicated by the sequential delivery task execution request information (step S4). Then, it is assumed that the next button is operated by the user P operating the UI unit 32 on the mobile object 30 that has reached the point B. Then, the mobile object 30 executes the sequential delivery task of moving to the second point C indicated by the sequential delivery task execution request information (step S5). Then, it is assumed that the next button is operated by the user P operating the UI unit 32 on the mobile object 30 that has reached the point C. The mobile object 30 executes the sequential delivery task of moving to the third point D indicated by the sequential delivery task execution request information (step S6). Then, it is assumed that the next button is operated by the user P operating the UI unit 32 on the mobile object 30 that has reached the last point D. Then, the mobile object 30 executes a return task (step S7) and returns to the point A.

In this manner, the control unit 36 executes the task of the task type assigned by the information processing apparatus 10 according to the task execution instruction information such as the call task execution instruction information, the delivery task execution instruction information, the return task execution instruction information, and the sequential delivery task execution instruction information received from the information processing apparatus 10.

Returning to FIG. 2, the description will be continued.

Next, the terminal device 20 will be described.

The terminal device 20 is an information processing apparatus operated by the user P.

The terminal device 20 includes a communication unit 21, a UI unit 22, a storage unit 23, and a control unit 24. The communication unit 21, the UI unit 22, and the storage unit 23 are communicably connected to the control unit 24 via a bus or the like.

The communication unit 21 is a communication interface that communicates with the information processing apparatus 10. The UI unit 22 has an input function of receiving various operations by the user P and an output function of outputting various types of information. The input function and the output function are similar to those described above. In the present embodiment, a mode in which the UI unit 22 is a touch panel integrally configured with an input function and an output function will be described as an example.

The storage unit 23 stores various data. The storage unit 35 is, for example, a semiconductor memory element such as a random access memory (RAM) or a flash memory, a hard disk, an optical disk, or the like. The control unit 24 executes various processes in the terminal device 20. The control unit 24 is realized by one or a plurality of processors. For example, the control unit 24 may be realized by causing a processor such as a CPU to execute a program, that is, by software. Furthermore, the control unit 36 may be realized by a processor such as a dedicated IC, that is, hardware. The control unit 36 may be realized by using software and hardware in combination.

Next, the information processing apparatus 10 will be described.

The information processing apparatus 10 is an information processing apparatus that executes management and the like of a plurality of mobile objects 30 included in the mobile object management system 1.

The information processing apparatus 10 includes a communication unit 11, a UI unit 12, a storage unit 13, and a control unit 14. The communication unit 11, the UI unit 12, and the storage unit 13 are communicably connected to the control unit 14 via a bus or the like.

The communication unit 11 is a communication interface that communicates with each of the terminal device 20 and the mobile object 30. The UI unit 12 has an input function of receiving various operations by the user P and an output function of outputting various types of information. The input function and the output function are similar to those described above.

The storage unit 13 stores various data. The storage unit 13 is, for example, a semiconductor memory element such as a RAM or a flash memory, a hard disk, an optical disk, or the like. The storage unit 13 may be a storage device provided outside the information processing apparatus 10. Furthermore, the storage unit 13 may be a storage medium in which programs and various types of information are downloaded via a LAN, the Internet, or the like and stored or temporarily stored.

In the present embodiment, the storage unit 13 stores a task management DB 13A and a mobile object management DB 13B.

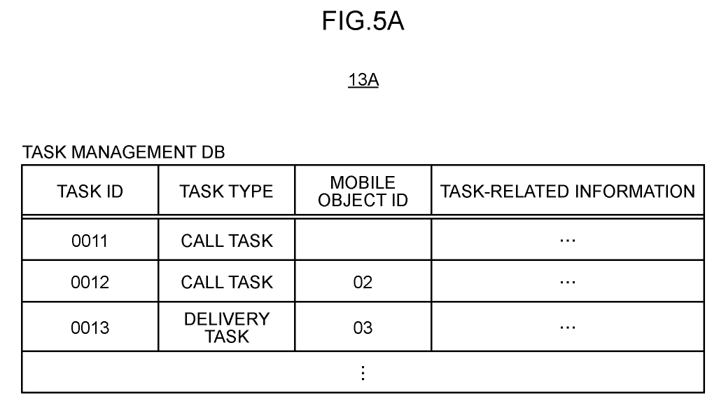

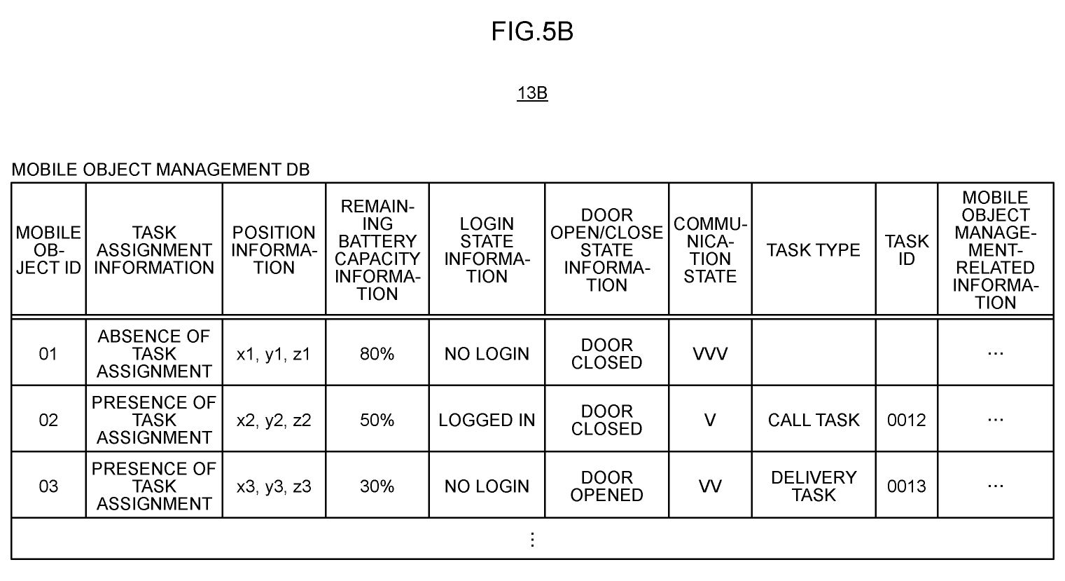

FIG. 5A is a schematic diagram of an example of a data configuration of the task management DB 13A.

The task management DB 13A is a database for managing tasks executed by each of the plurality of mobile objects 30 included in the mobile object management system 1. The data format of the task management DB 13A is not limited to the database. Note that the actual data structure of the task management DB 13A may be more complicated, but portions not directly related to the present invention are illustrated in a simplified manner from the actual data structure.

For example, the task management DB 13A is a database in which a task identification (ID), a task type, a mobile object ID, and task-related information are associated with each other.

The task ID is identification information of the task. The task type is information indicating a type of a task to be executed by the mobile object 30. As described above, the task type includes a call task, a delivery task, a sequential delivery task, a return task, and the like. The mobile object ID is identification information of the mobile object 30. The task-related information is information related to a task identified by a corresponding task ID. The task-related information may include, for example, information such as a destination of the mobile object 30, a task request time, a task end time, a task state, a task end time, and a task execution result.

FIG. 5B is a schematic diagram of an example of a data configuration of the mobile object management DB 13B.

The mobile object management DB 13B is a database for managing each of the plurality of mobile objects 30 included in the mobile object management system 1. The mobile object management DB 13B is an example of mobile object management information.

The data format of the mobile object management DB 13B is not limited to the database. Note that the actual data structure of the mobile object management DB 13B may be more complicated, but portions not directly related to the present invention are illustrated in a simplified manner.

For example, the mobile object management DB 13B is a database in which a mobile object ID, task assignment information, position information, remaining battery capacity information, login state information, door open/close state information, a communication state, a task type, a task ID, and mobile object management-related information are associated with each other.

The login state information is information indicating whether an operation by the user P on the UI unit 32 of the mobile object 30 is being received or not. In the present embodiment, the user P performs a login operation on the UI unit 32 of the mobile object 30, and when authentication by login is successful, the user P can operate the UI unit 32.

The mobile object management-related information is information related to the mobile object 30 identified by the corresponding mobile object ID. The mobile object management-related information includes, for example, identification information of an error occurring in the mobile object 30.

The task management DB 13A and the mobile object management DB 13B are updated by the control unit 14 described below.

Returning to FIG. 2, the description will be continued.

The control unit 14 executes various processes in the information processing apparatus 10.

In the present embodiment, a description will be given assuming that a robotics middleware framework (RMF) is installed in the control unit 14 in advance. The RMF is group control software. The group control means that the movement of the plurality of mobile objects 30 and other electronic devices is managed and controlled by one software. In the present embodiment, the RMF creates route information of each of the mobile objects 30 so as to avoid collision of the plurality of mobile objects 30, and notifies the mobile object 30 of the route information.

Here, in the related art, regardless of whether or not the mobile object 30 is executing a task, a new task is allocated to the mobile object 30, and effective management of the mobile object 30 may not be performed.

Therefore, the control unit 14 of the information processing apparatus 10 of the present embodiment specifies the mobile object 30 to which a new task is to be assigned according to the task assignment status represented by the task assignment information of each of the plurality of mobile objects 30 included in the mobile object management system 1, and performs control to cause the specified mobile object 30 to execute the new task.

Specifically, the control unit 14 includes a reception unit 14A, a specification unit 14B, a transmission unit 14C, and an update unit 14D. The reception unit 14A, the specification unit 14B, the transmission unit 14C, and the update unit 14D are realized by one or a plurality of processors. For example, each of the above units may be realized by causing a processor such as a CPU to execute a program, that is, by software.

Each of the above units may be realized by a processor such as a dedicated IC, that is, hardware. Each of the above units may be realized by using software and hardware in combination. When a plurality of processors is used, each processor may implement one of the units or two or more of the units. Furthermore, at least one of one or a plurality of functional units included in the control unit 14 may be mounted on an external information processing apparatus communicably connected to the information processing apparatus 10 via a network or the like.

The reception unit 14A receives various types of information from the terminal device 20 and the mobile object 30 of the user P.

Specifically, the reception unit 14A receives the call task execution request information from the terminal device 20.

The user P operates the UI unit 22 of the terminal device 20 to input call task execution request information including a specific position for calling the mobile object 30 and call task information indicating the call task. The control unit 24 of the terminal device 20 transmits the received call task execution request information to the information processing apparatus 10. The reception unit 14A of the information processing apparatus 10 receives call task execution request information from the terminal device 20.

The update unit 14D updates the task management DB 13A and the mobile object management DB 13B.

Every time new observation information and login state information are received from the mobile object 30, the update unit 14D updates the position information, the remaining battery capacity information, the login state information, the door open/close state information, and the communication state corresponding to the mobile object ID received together with the observation information and the login state information in the mobile object management DB 13B to values represented by the received observation information and login state information. Therefore, the latest observation information and login state information observed in each of the mobile objects 30 are registered in the mobile object management DB 13B for each of the mobile objects 30 included in the mobile object management system 1.

In addition, the update unit 14D updates the task management DB 13A according to the call task execution request information received by the reception unit 14A. Specifically, the update unit 14D assigns a new task ID to the call task represented by the call task execution request information received by the reception unit 14A, and registers the task type "call task" in the task management DB 13A in association with the task ID, thereby updating the task management DB 13A. By the processing, a new task is registered in the task management DB 13A.

When receiving the call task execution request information, the specification unit 14B specifies the mobile object 30 identified by the mobile object ID corresponding to the task assignment information indicating "absence of task assignment" in the mobile object management DB 13B as the call execution target mobile object of the execution target of the call task indicated by the call task execution request information.

This will be described with reference to FIG. 5B. For example, it is assumed that the information illustrated in FIG. 5B is registered in the mobile object management DB 13B. In this case, the specification unit 14B specifies the mobile object 30 identified by the mobile object ID "01" of which the task assignment information is "absence of task assignment" as the call execution target mobile object of the execution target of the call task represented by the call task execution request information.

When receiving the call task execution request information, the specification unit 14B may specify, as the call execution target mobile object, the mobile object 30 closest to the specific position where the position information of the mobile object 30 is the call position indicated by the call task execution request information among the mobile objects 30 identified by the mobile object ID corresponding to the task assignment information indicating "absence of task assignment" in the mobile object management DB 13B.

Further, when receiving the call task execution request information, the specification unit 14B may specify, as the call execution target mobile object, the mobile object 30 located in a predetermined area including the specific position indicated by the call task execution request information among the mobile objects 30 identified by the mobile object ID corresponding to the task assignment information indicating "absence of task assignment" in the mobile object management DB 13B. The predetermined area is, for example, a specific floor, a specific room, or the like. It is assumed that the predetermined area is a specific floor. In this case, the specification unit 14B specifies, as the call execution target mobile object, the mobile object 30 located on the same floor as the specific position that is the call position by the call task among the mobile objects 30 identified by the mobile object ID corresponding to the task assignment information indicating "absence of task assignment" in the mobile object management DB 13B.

In addition, when receiving the call task execution request information, the specification unit 14B may specify, as the call execution target mobile object, the mobile object 30 having a remaining battery capacity indicated by the remaining battery capacity information greater than or equal to a threshold among the mobile objects 30 identified by the mobile object ID corresponding to the task assignment information indicating absence of task assignment in the mobile object management DB 13B. The threshold may be set in advance. The threshold may be appropriately changeable by an operation instruction or the like of the UI unit 12 by the user P having administrator authority or the like.

Further, when receiving the call task execution request information, the specification unit 14B may specify the mobile object 30 that is not receiving the user operation on the UI unit 32 provided in the mobile object 30 among the mobile objects 30 identified by the mobile object ID corresponding to the task assignment information indicating "absence of task assignment" in the mobile object management DB 13B as the call execution target mobile object. In this case, when receiving the call task execution request information, the specification unit 14B may specify the mobile object 30 whose login state information is "no login" among the mobile objects 30 identified by the mobile object ID corresponding to the task assignment information indicating "absence of task assignment" in the mobile object management DB 13B as the call execution target mobile object.

When receiving the call task execution request information, the specification unit 14B may specify the mobile object 30 identified by the mobile object ID associated with the door open/close state information indicating the "door closed" state among the mobile objects 30 identified by the mobile object ID corresponding to the task assignment information indicating "absence of task assignment" in the mobile object management DB 13B as the call execution target mobile object.

The update unit 14D registers the "call task" in the task type corresponding to the mobile object ID of the call execution target mobile object specified by the specification unit 14B in the mobile object management DB 13B, and registers the task ID assigned to the call task represented by the received call task execution request information in the task ID.

Then, the transmission unit 14C transmits call task execution instruction information indicating a movement instruction to a specific position included in the call task execution request information received by the reception unit 14A to the mobile object 30 which is the call execution target mobile object specified by the specification unit 14B.

The control unit 36 of the mobile object 30 that has received the call task execution instruction information updates the task assignment information of the mobile object information 35A stored in the storage unit 35 of the mobile object 30 to "presence of task assignment". Then, the control unit 36 of the mobile object 30 transmits the mobile object ID of the mobile object 30 and task assignment information indicating "presence of task assignment" to the information processing apparatus 10.

Further, upon receiving the call task execution instruction information, the control unit 36 of the mobile object 30 executes the call task for moving to the specific position indicated by the received call task execution instruction information along the route indicated by the route information received from the RMF of the control unit 14.

Upon receiving the mobile object ID of the mobile object 30 and the task assignment information indicating "presence of task assignment" from the mobile object 30, the update unit 14D of the information processing apparatus 10 updates the task assignment information corresponding to the mobile object ID received from the mobile object 30 in the mobile object management DB 13B to "presence of task assignment". That is, the update unit 14D updates the task assignment information corresponding to the mobile object ID of the mobile object 30 to which the call task is assigned in the mobile object management DB 13B to "presence of task assignment".

The user P executes the login operation by operating the UI unit 32 of the mobile object 30 with respect to the mobile object 30 after the start of movement to the specific position by execution of the call task. Here, it is assumed that the control unit 36 of the mobile object 30 determines that the authentication by the login is successful. When the authentication by the login is successful, the user P can operate the UI unit 32 of the mobile object 30. When it is determined that authentication by login has succeeded, the control unit 36 of the mobile object 30 transmits login state information indicating "logged in" to the information processing apparatus 10. The update unit 14D of the information processing apparatus 10 updates the login state information corresponding to the mobile object ID of the mobile object 30 in the mobile object management DB 13B to "logged in".

It is assumed that the user P inputs the delivery task execution request information by operating the UI unit 32 of the mobile object 30. The user P operates the UI unit 32 of the mobile object 30 to input delivery task execution request information including a destination that is a delivery destination and delivery task information indicating the delivery task. The control unit 36 of the mobile object 30 transmits the received delivery task execution request information to the information processing apparatus 10.

In this case, the reception unit 14A of the information processing apparatus 10 receives the delivery task execution request information from the mobile object 30.

The update unit 14D assigns a new task ID to the delivery task represented by the delivery task execution request information received by the reception unit 14A, and registers a task type "delivery task" in the task management DB 13A in association with the task ID, thereby updating the task management DB 13A. By the processing, a new task is registered in the task management DB 13A.

In addition, the update unit 14D registers the "delivery task" in the task type corresponding to the mobile object ID of the mobile object 30 of the transmission source of the delivery task execution request information in the mobile object management DB 13B, and registers the task ID assigned to the delivery task represented by the received delivery task execution request information in the task ID. In addition, the update unit 14D updates the login state information corresponding to the mobile object ID in the mobile object management DB 13B to "no login".

Then, the transmission unit 14C transmits delivery task execution instruction information indicating a delivery instruction of the load to the destination, which is indicated by the delivery task execution request information received from the mobile object 30, to the mobile object 30 which is the transmission source of the delivery task execution request information. The control unit 36 of the mobile object 30 executes the delivery task of delivering the load to the destination indicated by the received delivery task execution instruction information along the route indicated by the route information received from the RMF of the control unit 14.

Therefore, when the user P gives an operation instruction to the UI unit 32 of the mobile object 30 after the execution of the call task is started, and the mobile object 30 receives the delivery task execution request information, the mobile object 30 preferentially executes the delivery task even during the execution of the call task. In other words, the delivery task that is an instruction given by the user P via the UI unit 32 of the mobile object 30 is preferentially executed.

On the other hand, when the specific position or the destination represented by the call task or the delivery task is reached and the return button representing the task completion is operated according to the operation instruction of the UI unit 32 by the user P, the control unit 36 of the mobile object 30 determines that the task completion information of the task being executed is received. In this case, the control unit 36 of the mobile object 30 updates the task assignment information in the mobile object information 35A to "absence of task assignment". Then, the control unit 36 of the mobile object 30 transmits the task completion information to the information processing apparatus 10.

When the reception unit 14A of the information processing apparatus 10 receives the task completion information from the mobile object 30, in a case where there is no other task for the mobile object 30 that is the transmission source of the task completion information, the transmission unit 14C transmits the return task execution instruction information to the mobile object 30.

The mobile object 30 that has received the return task execution instruction information executes a return task of returning to a predetermined standby position such as a dog in which a charger or the like is installed, and returns to the dog.

The update unit 14D of the information processing apparatus 10 updates the task assignment information corresponding to the mobile object ID of the mobile object 30 in the mobile object management DB 13B to "absence of task assignment".

Next, a case where the reception unit 14A receives the sequential delivery task execution request information from the terminal device 20 will be described.

The user P operates the UI unit 22 of the terminal device 20 to input the sequential delivery task execution request information including the sequential delivery task information indicating the sequential delivery task and the destinations to be visited in order and the delivery order of the destinations. The control unit 24 of the terminal device 20 transmits the received sequential delivery task execution request information to the information processing apparatus 10. The reception unit 14A of the information processing apparatus 10 receives the sequential delivery task execution request information from the terminal device 20.

The update unit 14D updates the task management DB 13A according to the sequential delivery task execution request information received by the reception unit 14A. Specifically, the update unit 14D assigns a new task ID to the sequential delivery task represented by the sequential task execution request information received by the reception unit 14A, and registers the task type "sequential delivery task" in the task management DB 13A in association with the task ID, thereby updating the task management DB 13A. In addition, the update unit 14D registers the destinations to be visited in order and the delivery order of the destinations indicated by the sequential delivery task execution request information in association with the task ID. Through these processes, a new task is registered in the task management DB 13A.

When receiving the sequential delivery task execution request information, the specification unit 14B may specify the mobile object 30 identified by the mobile object ID corresponding to the task assignment information indicating "absence of task assignment" in the mobile object management DB 13B as the sequential delivery execution target mobile object of the execution target indicated by the sequential delivery task execution request information in the same manner as described above.

In addition, the specification unit 14B may specify, as the sequential delivery execution target mobile object, the mobile object 30 that satisfies at least one of the following: located on the same floor as the plurality of destinations indicated by the sequential delivery task execution request information; a remaining battery capacity is equal to or greater than a threshold; a user operation on the UI unit 32 provided in the mobile object 30 is not received; and a "door closed" state, among the mobile objects 30 identified by the mobile object ID corresponding to the task assignment information indicating "absence of task assignment".

The update unit 14D registers the "sequential delivery task" in the task type corresponding to the mobile object ID of the sequential delivery execution target mobile object specified by the specification unit 14B in the mobile object management DB 13B, and registers the task ID assigned to the sequential delivery task represented by the received sequential delivery task execution request information in the task ID.

Then, the transmission unit 14C transmits call task execution instruction information indicating a movement instruction to the N-th destination included in the sequential delivery task execution request information received by the reception unit 14A to the mobile object 30 which is the sequential delivery execution target mobile object specified by the specification unit 14B. N is an integer of 1 or more, and is "1" in the initial state.

In addition, the control unit 36 of the mobile object 30 that has received the sequential delivery task execution instruction information updates the task assignment information of the mobile object information 35A stored in the storage unit 35 of the mobile object 30 to "presence of task assignment". Then, the control unit 36 of the mobile object 30 transmits the mobile object ID of the mobile object 30 and task assignment information indicating "presence of task assignment" to the information processing apparatus 10.

Furthermore, the control unit 36 of the mobile object 30 that has received the sequential delivery task execution instruction information executes the sequential delivery task of moving to the N-th destination indicated by the received sequential delivery task execution instruction information along the route indicated by the route information received from the RMF of the control unit 14.

Upon receiving the mobile object ID of the mobile object 30 and the task assignment information indicating "presence of task assignment" from the mobile object 30, the update unit 14D of the information processing apparatus 10 updates the task assignment information corresponding to the mobile object ID received from the mobile object 30 in the mobile object management DB 13B to "presence of task assignment". That is, the update unit 14D updates the task assignment information corresponding to the mobile object ID of the mobile object 30 to which the sequential delivery task is assigned in the mobile object management DB 13B to "presence of task assignment".

In addition, every time the mobile object 30 arrives at the destination and the user P operates the next button on the UI unit 32 of the mobile object 30, the transmission unit 14C counts up the value of N by 1, and transmits call task execution instruction information indicating a movement instruction to the next destination.

Therefore, when the next button is operated by the user P operating the UI unit 32 on the mobile object 30 that has reached the N-th destination, the mobile object 30 moves to the destination of the next order indicated by the sequential delivery task execution request information.

Here, there is a case where the user P operates the next button a plurality of times by operating the UI unit 32 of the mobile object 30, and inputs an instruction to avoid the next destination and deliver to the destinations beyond the next.

In this case, according to the sequential delivery task execution instruction information indicating the sequential delivery task of delivering the load via the plurality of destinations in order, the reception unit 14A of the information processing apparatus 10 avoids the movement from the mobile object 30 moving to the destination of the next order to the destination of the next order and receives the movement request information to the destinations beyond the next.

In this case, the update unit 14D of the information processing apparatus 10 updates the destinations to be visited in order and the delivery order of the destinations, corresponding to the task ID of the sequential delivery task being executed in the mobile object 30 in the task management DB 13A to the order and the destination indicated by the received movement request information.

Then, the transmission unit 14C may transmit the sequential delivery task execution instruction information represented by the movement request information to the mobile object 30. That is, the transmission unit 14C transmits the sequential delivery task execution instruction information indicating the execution instruction of the sequential delivery task to the destination beyond the next set according to the operation of the UI unit 32 of the mobile object 30 by the user P instead of the next destination before the operation of the UI unit 32 by the user P is performed. The mobile object 30 that has received the movement request information executes a sequential delivery task toward the destinations beyond the next.

Therefore, when the user P gives an operation instruction to the UI unit 32 of the mobile object 30 after the execution of the sequential delivery task is started, and an operation instruction to go to the destination beyond the next is given, the information processing apparatus 10 can control the mobile object 30 to preferentially execute the sequential delivery task according to the operation instruction. That is, in the information processing apparatus 10 of the present embodiment, it is possible to perform control such that an instruction issued by the user P via the UI unit 32 of the mobile object 30 is preferentially executed.

Then, it is assumed that the next button is operated by the user P operating the UI unit 32 on the mobile object 30 that has reached the final destination. Then, the control unit 36 of the mobile object 30 determines that the task completion information of the task being executed is received. In this case, the control unit 36 of the mobile object 30 updates the task assignment information in the mobile object information 35A to "absence of task assignment". Then, the control unit 36 of the mobile object 30 transmits the task completion information to the information processing apparatus 10.

When the reception unit 14A of the information processing apparatus 10 receives the task completion information from the mobile object 30, in a case where there is no other task for the mobile object 30 that is the transmission source of the task completion information, the transmission unit 14C transmits the return task execution instruction information to the mobile object 30.

The mobile object 30 that has received the return task execution instruction information executes a return task of returning to a predetermined standby position such as a dog in which a charger or the like is installed, and returns to the dog.

The update unit 14D of the information processing apparatus 10 updates the task assignment information corresponding to the mobile object ID of the mobile object 30 in the mobile object management DB 13B to "absence of task assignment".

Next, an example of a flow of information processing executed by the mobile object management system 1 of the present embodiment will be described.

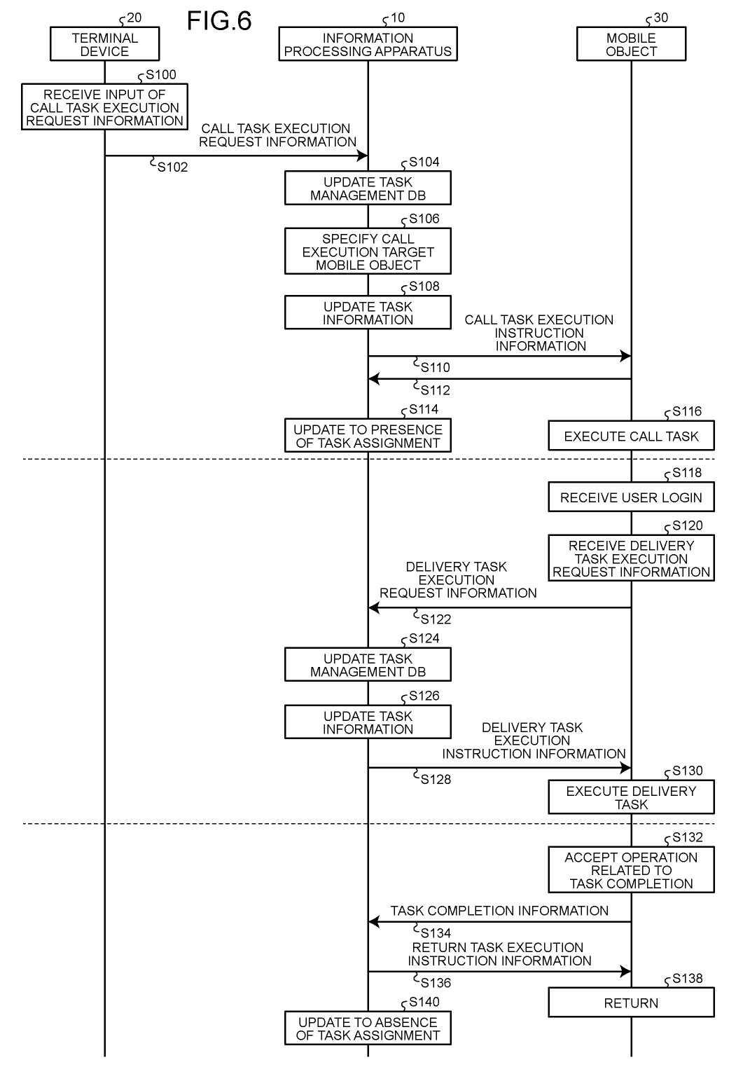

FIG. 6 is a sequence diagram illustrating an example of a flow of information processing executed by the mobile object management system 1.

The user P operates the UI unit 22 of the terminal device 20 to input call task execution request information including a specific position for calling the mobile object 30 and call task information indicating the call task. The control unit 24 of the terminal device 20 receives an input of the call task execution request information (step S100). The control unit 24 of the terminal device 20 transmits the call task execution request information received in step S100 to the information processing apparatus 10 (step S102). The reception unit 14A of the information processing apparatus 10 receives call task execution request information from the terminal device 20.

The update unit 14D of the information processing apparatus 10 updates the task management DB 13A according to the call task execution request information received in step S102 (step S104). The update unit 14D assigns a new task ID to the call task represented by the call task execution request information received by the reception unit 14A, and registers a task type "call task" in the task management DB 13A in association with the task ID, thereby updating the task management DB 13A. By the processing, a new task is registered in the task management DB 13A.

The specification unit 14B specifies the mobile object 30 identified by the mobile object ID corresponding to the task assignment information indicating "absence of task assignment" in the mobile object management DB 13B as the call execution target mobile object of the execution target of the call task indicated by the call task execution request information (step S106).

As described above, the specification unit 14B may specify, as the call execution target mobile object, the mobile object 30 that satisfies at least one of the following: the position information of the mobile object 30 is closest to the specific position that is the call position indicated by the call task execution request information; the position of the mobile object 30 is on the same floor (area) as the specific position that is the call position by the call task; the remaining battery capacity is greater than or equal to the threshold; the login state information indicates the "no login" state; and the door open/close state information indicates the "door closed" state, among the mobile objects 30 identified by the mobile object ID corresponding to the task assignment information indicating "absence of task assignment" in the mobile object management DB 13B.

The update unit 14D of the information processing apparatus 10 registers the "call task" in the task type corresponding to the mobile object ID of the call execution target mobile object specified in step S106 in the mobile object management DB 13B, and registers the task ID assigned to the call task represented by the received call task execution request information in the task ID (step S108).

The transmission unit 14C of the information processing apparatus 10 transmits call task execution instruction information indicating a movement instruction to a specific position included in the call task execution request information received by the reception unit 14A to the mobile object 30 which is the call execution target mobile object specified in step S106 (step S110).

The control unit 36 of the mobile object 30 that has received the call task execution instruction information updates the task assignment information of the mobile object information 35A stored in the storage unit 35 of the mobile object 30 to "presence of task assignment". Then, the control unit 36 of the mobile object 30 transmits the mobile object ID of the mobile object 30 and the task assignment information indicating "presence of task assignment" to the information processing apparatus 10 (step S112).

Upon receiving the mobile object ID of the mobile object 30 and the task assignment information indicating "presence of task assignment" from the mobile object 30, the update unit 14D of the information processing apparatus 10 updates the task assignment information corresponding to the mobile object ID received from the mobile object 30 in the mobile object management DB 13B to "presence of task assignment" (step S114).

Further, upon receiving the call task execution instruction information, the control unit 36 of the mobile object 30 executes the call task for moving to the specific position indicated by the received call task execution instruction information along the route indicated by the route information received from the RMF of the control unit 14 (step S116).

By executing the call task, the user P executes the login operation by operating the UI unit 32 of the mobile object 30 with respect to the mobile object 30 after the start of movement to the specific position. The mobile object 30 receives the login operation (step S118). Here, it is assumed that the control unit 36 of the mobile object 30 determines that the authentication by the login is successful. When the authentication by the login is successful, the user P can operate the UI unit 32 of the mobile object 30. When it is determined that authentication by login has succeeded, the control unit 36 of the mobile object 30 transmits login state information indicating "logged in" to the information processing apparatus 10. The update unit 14D of the information processing apparatus 10 updates the login state information corresponding to the mobile object ID of the mobile object 30 in the mobile object management DB 13B to "logged in".

It is assumed that the user P inputs the delivery task execution request information by operating the UI unit 32 of the mobile object 30. The user P operates the UI unit 32 of the mobile object 30 to input delivery task execution request information including a destination that is a delivery destination and delivery task information indicating the delivery task (step S120). The control unit 36 of the mobile object 30 transmits the received delivery task execution request information to the information processing apparatus 10 (step S122).

The reception unit 14A of the information processing apparatus 10 receives the delivery task execution request information from the mobile object 30. The update unit 14D of the information processing apparatus 10 assigns a new task ID to the delivery task represented by the delivery task execution request information received in step S122, and registers the task type "delivery task" in the task management DB 13A in association with the task ID, thereby updating the task management DB 13A (step S124).

In addition, the update unit 14D registers the "delivery task" in the task type corresponding to the mobile object ID of the mobile object 30 of the transmission source of the delivery task execution request information in the mobile object management DB 13B, and registers the task ID assigned to the delivery task represented by the received delivery task execution request information in the task ID (step S126). In addition, the update unit 14D updates the login state information corresponding to the mobile object ID in the mobile object management DB 13B to "no login" (step S126).

Then, the transmission unit 14C of the information processing apparatus 10 transmits delivery task execution instruction information indicating a delivery instruction of a load to the destination, which is indicated by the delivery task execution request information received from the mobile object 30, to the mobile object 30 as a transmission source of the delivery task execution request information (step S128). The control unit 36 of the mobile object 30 executes the delivery task of delivering the load to the destination indicated by the received delivery task execution instruction information along the route indicated by the route information received from the RMF of the control unit 14 (step S130).

Therefore, when the user P gives an operation instruction to the UI unit 32 of the mobile object 30 after the execution of the call task is started, and the mobile object 30 receives the delivery task execution request information, the mobile object 30 preferentially executes the delivery task even during the execution of the call task. In other words, the delivery task that is an instruction given by the user P via the UI unit 32 of the mobile object 30 is preferentially executed.

On the other hand, when the specific position or the destination represented by the call task or the delivery task is reached and the return button representing the task completion is operated according to the operation instruction of the UI unit 32 by the user P, the control unit 36 of the mobile object 30 determines that the task completion information of the task being executed is received (step S132). In this case, the control unit 36 of the mobile object 30 updates the task assignment information in the mobile object information 35A to "absence of task assignment". Then, the control unit 36 of the mobile object 30 transmits task completion information to the information processing apparatus 10 (step S134).

When the reception unit 14A of the information processing apparatus 10 receives the task completion information from the mobile object 30, in a case where there is no other task for the mobile object 30 that is the transmission source of the task completion information, the transmission unit 14C transmits the return task execution instruction information to the mobile object 30 (step S136).

The mobile object 30 that has received the return task execution instruction information executes a return task of returning to a predetermined standby position such as a dog in which a charger or the like is installed, and returns to the dog (step S138).

The update unit 14D of the information processing apparatus 10 updates the task assignment information corresponding to the mobile object ID of the mobile object 30 in the mobile object management DB 13B to "absence of task assignment" (step S140). Therefore, task assignment information indicating "absence of task assignment" is registered in the mobile object management DB 13B with respect to the mobile object 30 in a state where no task is assigned.

Next, an example of a flow of information processing executed by the information processing apparatus 10 according to the present embodiment will be described.

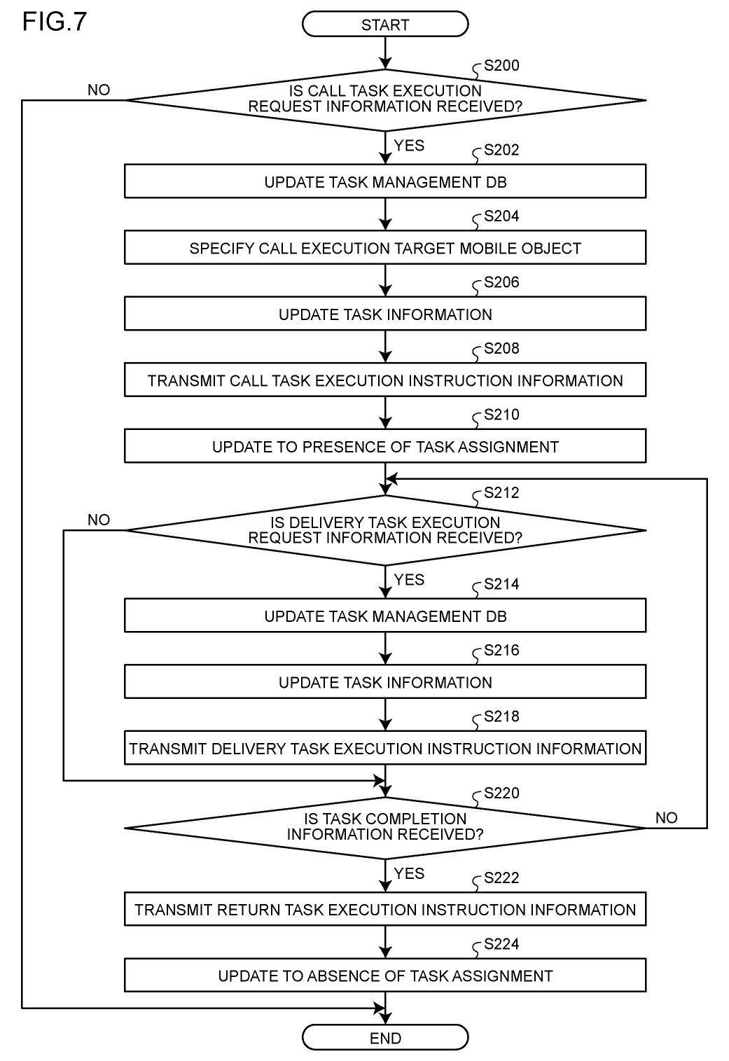

FIG. 7 is a flowchart illustrating an example of a flow of information processing executed by the information processing apparatus 10 according to the present embodiment.

The reception unit 14A of the information processing apparatus 10 determines whether or not the call task execution request information has been received from the terminal device 20 (step S200). When a negative determination is made in step S200 (step S200: No), this routine is ended. When an affirmative determination is made in step S200 (step S200: Yes), the process proceeds to step S202.

In step S202, the update unit 14D updates the task management DB 13A according to the call task execution request information received in step S200 (step S202). The update unit 14D updates the task management DB 13A by assigning a new task ID to the call task represented by the call task execution request information received in step S200, and registering the task type "call task" in the task management DB 13A in association with the task ID. By the processing, a new task is registered in the task management DB 13A.

Next, the specification unit 14B specifies the mobile object 30 identified by the mobile object ID corresponding to the task assignment information indicating "absence of task assignment" in the mobile object management DB 13B as the call execution target mobile object of the execution target of the call task indicated by the call task execution request information (step S204). The specification unit 14B may specify, as the call execution target mobile object, the mobile object 30 that satisfies at least one of the following: the position information of the mobile object 30 is closest to the specific position that is the call position indicated by the call task execution request information; the position of the mobile object on the same floor (area) as the specific position that is the call position by the call task; the remaining battery capacity equal to or greater than the threshold; the login state information indicating "no login"; and the door open/close state information indicating the "door closed" state, among the mobile objects 30 identified by the mobile object ID corresponding to the task assignment information indicating "absence of task assignment" in the mobile object management DB 13B.

The update unit 14D registers the "call task" in the task type corresponding to the mobile object ID of the call execution target mobile object specified in step S204 in the mobile object management DB 13B, and registers the task ID assigned to the call task represented by the received call task execution request information in the task ID (step S206).

The transmission unit 14C transmits call task execution instruction information indicating a movement instruction to a specific position included in the call task execution request information received in step S200 to the mobile object 30 which is the call execution target mobile object specified in step S204 (step S208).

The control unit 36 of the mobile object 30 that has received the call task execution instruction information updates the task assignment information of the mobile object information 35A stored in the storage unit 35 of the mobile object 30 to "presence of task assignment". Then, the control unit 36 of the mobile object 30 transmits the mobile object ID of the mobile object 30 and task assignment information indicating "presence of task assignment" to the information processing apparatus 10. Further, upon receiving the call task execution instruction information, the control unit 36 of the mobile object 30 executes the call task for moving to the specific position indicated by the received call task execution instruction information along the route indicated by the route information received from the RMF of the control unit 14.

Upon receiving the mobile object ID of the mobile object 30 and the task assignment information indicating "presence of task assignment" from the mobile object 30, the update unit 14D of the information processing apparatus 10 updates the task assignment information corresponding to the mobile object ID received from the mobile object 30 in the mobile object management DB 13B to "presence of task assignment" (step S210).

The reception unit 14A determines whether the delivery task execution request information has been received from the mobile object 30 (step S212). When a negative determination is made in step S212 (step S212: No), the process proceeds to step S220 described below. When an affirmative determination is made in step S212 (step S212: Yes), the process proceeds to step S214.

In step S214, the update unit 14D assigns a new task ID to the delivery task represented by the delivery task execution request information received in step S212, and registers the task type "delivery task" in the task management DB 13A in association with the task ID, thereby updating the task management DB 13A (step S214).

In addition, the update unit 14D registers the "delivery task" in the task type corresponding to the mobile object ID of the mobile object 30 of the transmission source of the delivery task execution request information in the mobile object management DB 13B, and registers the task ID assigned to the delivery task represented by the received delivery task execution request information in the task ID (step S216). In addition, the update unit 14D updates the login state information corresponding to the mobile object ID in the mobile object management DB 13B to "no login".

Then, the transmission unit 14C transmits delivery task execution instruction information indicating a delivery instruction of the load to the destination, which is indicated by the delivery task execution request information received from the mobile object 30, to the mobile object 30 as a transmission source of the delivery task execution request information (step S218). The control unit 36 of the mobile object 30 executes the delivery task of delivering the load to the destination indicated by the received delivery task execution instruction information along the route indicated by the route information received from the RMF of the control unit 14.

Next, the reception unit 14A determines whether task completion information is received from the mobile object 30 (step S220). When a negative determination is made in step S220 (step S220: No), the process returns to step S212. When an affirmative determination is made in step S220 (step S220: Yes), the process proceeds to step S222.

In step S222, when there is no other task for the mobile object 30 that is the transmission source of the task completion information received in step S220, the transmission unit 14C transmits the return task execution instruction information to the mobile object 30 (step S222). The mobile object 30 that has received the return task execution instruction information executes a return task of returning to a predetermined standby position such as a dog in which a charger or the like is installed, and returns to the dog.

The update unit 14D of the information processing apparatus 10 updates the task assignment information corresponding to the mobile object ID of the mobile object 30 in the mobile object management DB 13B to "absence of task assignment" (step S224). Therefore, task assignment information indicating "absence of task assignment" is registered in the mobile object management DB 13B with respect to the mobile object 30 in a state where no task is assigned.

Then, this routine is ended.

As described above, the information processing apparatus 10 according to the present embodiment includes the reception unit 14A, the specification unit 14B, the transmission unit 14C, and the update unit 14D. The reception unit 14A receives call task execution request information including call task information indicating a call task in which the mobile object 30 is called to a specific position and the specific position. When receiving the call task execution request information, the specification unit 14B specifies the mobile object 30 identified by the mobile object ID corresponding to the task assignment information indicating "absence of task assignment" in the mobile object management DB 13B in which at least the mobile object ID and the task assignment information are associated with each other as the call execution target mobile object of the execution target of the call task. The transmission unit 14C transmits call task execution instruction information indicating a movement instruction to a specific position included in the call task execution request information to the specified call execution target mobile object.

In the related art, regardless of whether or not the mobile object 30 is executing a task, a new task is allocated to the mobile object 30, and effective management of the mobile object 30 may not be performed.

On the other hand, in the information processing apparatus 10 of the present embodiment, when receiving the call task execution request information, the specification unit 14B specifies the mobile object 30 identified by the mobile object ID corresponding to the task assignment information indicating "absence of task assignment" in the mobile object management DB 13B in which at least the mobile object ID and the task assignment information are associated with each other as the call execution target mobile object which is the execution target of the call task.

Therefore, in the information processing apparatus 10 of the present embodiment, it is possible to prevent a new task from being assigned to the mobile object 30 that is executing the task, and to manage each of the plurality of mobile objects 30 included in the mobile object management system 1 so as to be able to be effectively used.

Therefore, the information processing apparatus 10 of the present embodiment can effectively use the mobile object 30.

Further, in the information processing apparatus 10 of the present embodiment, when receiving the call task execution request information, the specification unit 14B specifies the mobile object 30 whose position information is the closest to the specific position among the mobile objects 30 identified by the mobile object ID whose task assignment information indicates "absence of task assignment" in the mobile object management DB 13B as the call execution target mobile object.

Therefore, in the information processing apparatus 10 of the present embodiment, among the mobile objects 30 to which no task is assigned, the mobile object 30 that can reach the specific position most quickly and with the smallest energy consumption can be specified as the call execution target mobile object.

Further, in the information processing apparatus 10 of the present embodiment, when receiving the call task execution request information, the specification unit 14B specifies, as the call execution target mobile object, the mobile object 30 located in a predetermined area including the specific position represented by the call task execution request information among the mobile objects 30 identified by the mobile object ID in which the task assignment information represents "absence of task assignment" in the mobile object management DB 13B.

Therefore, in the information processing apparatus 10 of the present embodiment, among the mobile objects 30 to which no task is assigned, the mobile object 30 located in the same predetermined area as the specific position such as the same floor can be specified as the call execution target mobile object.

Further, in the information processing apparatus 10 of the present embodiment, when receiving the call task execution request information, the specification unit 14B specifies, as the call execution target mobile object, the mobile object 30 having a remaining battery capacity indicated by the remaining battery capacity information greater than or equal to a threshold among the mobile objects 30 identified by the mobile object ID of which the task assignment information indicates "absence of task assignment" in the mobile object management DB 13B.

Therefore, in the information processing apparatus 10 of the present embodiment, among the mobile objects 30 to which no task is assigned, the mobile object 30 having a remaining battery capacity equal to or higher than a threshold can be specified as the call execution target mobile object.

Further, in the information processing apparatus 10 of the present embodiment, when receiving the call task execution request information, the specification unit 14B specifies the mobile object 30 that is not receiving the user operation on the UI unit 32 (input unit) provided in the mobile object 30 among the mobile objects 30 identified by the mobile object ID of which the task assignment information indicates "absence of task assignment" in the mobile object management DB 13B as the call execution target mobile object.

Therefore, in the information processing apparatus 10 of the present embodiment, among the mobile objects 30 to which no task is assigned, the mobile object 30 that is not receiving an operation by the user P can be specified as the call execution target mobile object.

Further, in the information processing apparatus 10 of the present embodiment, when receiving the call task execution request information, the specification unit 14B specifies the mobile object 30 identified by the mobile object ID associated with the door open/close state information indicating the "door closed" state among the mobile objects 30 identified by the mobile object ID in which the task assignment information indicates "absence of task assignment" in the mobile object management DB 13B as the call execution target mobile object.

Therefore, in the information processing apparatus 10 of the present embodiment, among the mobile objects 30 to which no task is assigned, the mobile object 30 in a state in which the door provided in the mobile object 30 is closed can be specified as the call execution target mobile object.

Further, in the information processing apparatus 10 of the present embodiment, the update unit 14D updates the task assignment information corresponding to the mobile object ID of the specified call execution target mobile object in the mobile object management DB 13B from "absence of task assignment" to "presence of task assignment".

Therefore, in the information processing apparatus 10 of the present embodiment, the task assignment information for the mobile object 30 to which the task is assigned can be updated to "presence of task assignment" indicating the state in which the task is assigned.

In addition, in the information processing apparatus 10 of the present embodiment, in a case where the task completion information is received from the mobile object 30, the task assignment information associated with the mobile object ID of the mobile object 30 which is the transmission source of the task completion information in the mobile object management DB 13B is updated to "absence of task assignment".

Therefore, in the information processing apparatus 10 of the present embodiment, the task assignment information for the mobile object 30 that has finished the execution of the task can be updated to "absence of task assignment" indicating a state where no task is assigned.

Further, in the information processing apparatus 10 according to the present embodiment, in a case where the reception unit 14A receives delivery task execution request information indicating an execution request of a delivery task of delivering a load to the destination from the call execution target mobile object after the start of movement to the specific position, the update unit 14D updates the task type associated with the mobile object ID of the call execution target mobile object in the mobile object management DB 13B to the delivery task. Then, the transmission unit 14C transmits, to the call execution target mobile object, delivery task execution instruction information indicating a delivery instruction of the load from the current position to the destination.

Therefore, in the information processing apparatus 10 of the present embodiment, when the user P gives an operation instruction to the UI unit 32 of the mobile object 30 after the execution of the call task is started, and the mobile object 30 receives the delivery task execution request information, the mobile object 30 can preferentially execute the delivery task even during the execution of the call task. That is, it is possible to cause the mobile object 30 to preferentially execute the delivery task that is an instruction made by the user P via the UI unit 32 of the mobile object 30.

In addition, in the information processing apparatus 10 of the present embodiment, the reception unit 14A avoids movement to a destination of the next order from the mobile object 30 moving to the destination of the next order and receives movement request information to the destinations beyond the next according to the sequential delivery task execution instruction information indicating a sequential delivery task of delivering a load via a plurality of destinations in order. When the reception unit 14A receives the movement request information, the transmission unit 14C transmits the sequential delivery task execution instruction information represented by the movement request information to the mobile object 30.

For this reason, in the information processing apparatus 10 of the present embodiment, when the user P gives an operation instruction to the UI unit 32 of the mobile object 30 after the execution of the sequential delivery task is started and an operation instruction to go to the destinations beyond the next is given, the mobile object 30 can be controlled to preferentially execute the sequential delivery task according to the operation instruction. That is, in the information processing apparatus 10 of the present embodiment, it is possible to perform control such that an instruction issued by the user P via the UI unit 32 of the mobile object 30 is preferentially executed.

Next, an example of a hardware configuration of the information processing apparatus 10, the terminal device 20, and the mobile object 30 of the above embodiments will be described.

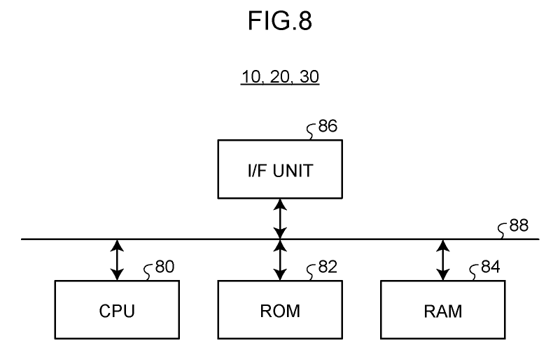

FIG. 8 is a hardware configuration diagram of an example of the information processing apparatus 10, the terminal device 20, and the mobile object 30 of the embodiment.

The information processing apparatus 10, the terminal device 20, and the mobile object 30 according to the above embodiment have a hardware configuration using a normal computer in which a central processing unit (CPU) 80, a read only memory (ROM) 82, a random access memory (RAM) 84, an I/F 86, and the like are connected to one another via a bus 88.

The CPU 80 is an arithmetic device that controls the information processing apparatus 10, the terminal device 20, and the mobile object 30 of the above embodiments. The ROM 82 stores a program or the like that realizes information processing by the CPU 80. The RAM 84 stores data necessary for various processes by the CPU 80. The I/F 86 is an interface connected to a storage unit, an input unit, an output unit, a sensor, a communication unit, and the like to transmit and receive data.

In the information processing apparatus 10, the terminal device 20, and the mobile object 30 of the above embodiments, the CPU 80 reads the program from the ROM 82 onto the RAM 84 and executes the program, whereby the above functional units are realized on the computer.

Note that the program for executing each of the above-described processes executed by the information processing apparatus 10, the terminal device 20, and the mobile object 30 of the above embodiments may be stored in a hard disk drive (HDD). Furthermore, the program for executing each of the above-described processes executed by the information processing apparatus 10, the terminal device 20, and the mobile object 30 of the above embodiments may be provided by being incorporated in the ROM 82 in advance.

Furthermore, the program for executing the above-described processes executed by the information processing apparatus 10, the terminal device 20, and the mobile object 30 according to the above embodiments may be stored as a file in an installable format or an executable format in a computer-readable storage medium such as a CD-ROM, a CD-R, a memory card, a digital versatile disk (DVD), or a flexible disk (FD) and provided as a computer program product. Furthermore, the program for executing the information processing executed by the information processing apparatus 10, the terminal device 20, and the mobile object 30 of the above embodiments may be stored on a computer connected to a network such as the Internet and provided by being downloaded via the network. Furthermore, the program for executing the information processing executed by the information processing apparatus 10, the terminal device 20, and the mobile object 30 of the above embodiments may be provided or distributed via a network such as the Internet.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

Note that the present technology can also have the following configurations.

(1)

An information processing apparatus including:

a reception unit configured to receive call task execution request information including call task information and a specific position, the call task information indicating a call task in which a mobile object is called to the specific position;

a specification unit configured to specify, as a call execution target mobile object of an execution target of the call task, the mobile object identified by mobile object identification information corresponding to task assignment information indicating absence of task assignment in mobile object management information in which the mobile object identification information and the task assignment information are at least associated with each other, when receiving the call task execution request information; and

a transmission unit configured to transmit, to the call execution target mobile object, call task execution instruction information indicating a movement instruction to the specific position included in the call task execution request information.

(2)

The information processing apparatus according to (1), in which

position information of the mobile object identified by the mobile object identification information is further associated with the mobile object management information, and

the specification unit is configured to specify, as the call execution target mobile object, the mobile object whose position information is closest to the specific position among the mobile objects identified by the mobile object identification information for which the task assignment information indicates absence of task assignment in the mobile object management information, when receiving the call task execution request information.

(3)

The information processing apparatus according to (1) or (2), in which

position information of the mobile object identified by the mobile object identification information is further associated with the mobile object management information, and

the specification unit is configured to specify, as the call execution target mobile object, the mobile object located in a predetermined area including the specific position indicated by the call task execution request information among the mobile objects identified by the mobile object identification information for which the task assignment information indicates absence of task assignment in the mobile object management information, when receiving the call task execution request information.

(4)

The information processing apparatus according to any one of (1) to (3), in which

the mobile object management information is further associated with remaining battery capacity information of the mobile object identified by the mobile object identification information, and

the specification unit is configured to specify, as the call execution target mobile object, the mobile object whose remaining battery capacity indicated by remaining battery capacity information is greater than or equal to a threshold among the mobile objects identified by the mobile object identification information for which the task assignment information indicates absence of task assignment in the mobile object management information, when receiving the call task execution request information.

(5)

The information processing apparatus according to any one of (1) to (4), in which

the specification unit is configured to specify, as the call execution target mobile object, the mobile object that is not receiving a user operation on an input unit provided in the mobile object among the mobile objects identified by the mobile object identification information for which the task assignment information indicates absence of task assignment in the mobile object management information, when receiving the call task execution request information.

(6)

The information processing apparatus according to any one of (1) to (5), in which

the mobile object management information is further associated with door open/close state information of a door provided in the mobile object identified by the mobile object identification information, and

the specification unit is configured to specify, as the call execution target mobile object, the mobile object identified by the mobile object identification information associated with the door open/close state information indicating a door closed state among the mobile objects identified by the mobile object identification information for which the task assignment information indicates absence of task assignment in the mobile object management information, when receiving the call task execution request information.

(7)

The information processing apparatus according to any one of (1) to (6), including

an update unit configured to update, from absence of task assignment to presence of task assignment, the task assignment information corresponding to the mobile object identification information of the call execution target mobile object in the mobile object management information.

(8)

The information processing apparatus according to (7), in which

the update unit is configured to update, to absence of task assignment, the task assignment information associated with the mobile object identification information of the mobile object which is a transmission source of task completion information in the mobile object management information, when receiving the task completion information from the mobile object.

(9)

The information processing apparatus according to (7) or (8), in which

when the reception unit receives delivery task execution request information representing an execution request of a delivery task of delivering a load to a destination from the call execution target mobile object after a start of movement to the specific position,

the update unit is configured to update, to the delivery task, a task type associated with the mobile object identification information of the call execution target mobile object in the mobile object management information, and

the transmission unit is configured to transmit, to the call execution target mobile object, delivery task execution instruction information indicating a delivery instruction of a load from a current position to the destination.

(10)

The information processing apparatus according to any one of (1) to (9), in which,

when the reception unit receives, from the mobile object moving to a destination of a next order, movement request information for avoiding movement to the destination of the next order and for moving to destinations beyond the next order according to sequential delivery task execution instruction information representing a sequential delivery task of delivering loads via a plurality of destinations in order,

the transmission unit is configured to transmit the sequential delivery task execution instruction information indicated by the movement request information to the mobile object.

(11)

An information processing method executed by an information processing apparatus, the method including:

a step of receiving call task execution request information including call task information and a specific position, the call task information indicating a call task in which a mobile object is called to the specific position;

a step of specifying, as a call execution target mobile object of an execution target of the call task, the mobile object identified by mobile object identification information corresponding to task assignment information indicating absence of task assignment in mobile object management information in which the mobile object identification information and the task assignment information are at least associated with each other, when receiving the call task execution request information; and

a step of transmitting, to the call execution target mobile object, call task execution instruction information indicating a movement instruction to the specific position included in the call task execution request information.

(12)

An information processing program causing a computer to perform:

a step of receiving call task execution request information including call task information and a specific position, the call task information indicating a call task in which a mobile object is called to the specific position;

a step of specifying, as a call execution target mobile object of an execution target of the call task, the mobile object identified by mobile object identification information corresponding to task assignment information indicating absence of task assignment in mobile object management information in which the mobile object identification information and the task assignment information are at least associated with each other, when receiving the call task execution request information; and

a step of transmitting, to the call execution target mobile object, call task execution instruction information indicating a movement instruction to the specific position included in the call task execution request information.

What is claimed is:

1. An information processing apparatus comprising:
a memory; and
a hardware processor coupled to the memory and configured to:
receive call task execution request information including call task information and a specific position, the call task information indicating a call task in which a mobile object is called to the specific position;
specify, as a call execution target mobile object of an execution target of the call task, the mobile object identified by mobile object identification information corresponding to task assignment information indicating absence of task assignment in mobile object management information in which the mobile object identification information and the task assignment information are at least associated with each other, when receiving the call task execution request information; and
transmit, to the call execution target mobile object, call task execution instruction information indicating a movement instruction to the specific position included in the call task execution request information.

2. The information processing apparatus according to claim 1, wherein
position information of the mobile object identified by the mobile object identification information is further associated with the mobile object management information, and
the hardware processor is configured to specify, as the call execution target mobile object, the mobile object whose position information is closest to the specific position among the mobile objects identified by the mobile object identification information for which the task assignment information indicates absence of task assignment in the mobile object management information, when receiving the call task execution request information.

3. The information processing apparatus according to claim 1, wherein
position information of the mobile object identified by the mobile object identification information is further associated with the mobile object management information, and
the hardware processor is configured to specify, as the call execution target mobile object, the mobile object located in a predetermined area including the specific position indicated by the call task execution request information among the mobile objects identified by the mobile object identification information for which the task assignment information indicates absence of task assignment in the mobile object management information, when receiving the call task execution request information.

4. The information processing apparatus according to claim 1, wherein
the mobile object management information is further associated with remaining battery capacity information of the mobile object identified by the mobile object identification information, and
the hardware processor is configured to specify, as the call execution target mobile object, the mobile object whose remaining battery capacity indicated by remaining battery capacity information is greater than or equal to a threshold among the mobile objects identified by the mobile object identification information for which the task assignment information indicates absence of task assignment in the mobile object management information, when receiving the call task execution request information.

5. The information processing apparatus according to claim 1, wherein
the hardware processor is configured to specify, as the call execution target mobile object, the mobile object that is not receiving a user operation on the mobile object among the mobile objects identified by the mobile object identification information for which the task assignment information indicates absence of task assignment in the mobile object management information, when receiving the call task execution request information.

6. The information processing apparatus according to claim 1, wherein
the mobile object management information is further associated with door open/close state information of a door provided in the mobile object identified by the mobile object identification information, and
the hardware processor is configured to specify, as the call execution target mobile object, the mobile object identified by the mobile object identification information associated with the door open/close state information indicating a door closed state among the mobile objects identified by the mobile object identification information for which the task assignment information indicates absence of task assignment in the mobile object management information, when receiving the call task execution request information.

7. The information processing apparatus according to claim 1, wherein the hardware processor is further configured to update, from absence of task assignment to presence of task assignment, the task assignment information corresponding to the mobile object identification information of the call execution target mobile object in the mobile object management information.

8. The information processing apparatus according to claim 7, wherein
the hardware processor is configured to update, to absence of task assignment, the task assignment information associated with the mobile object identification information of the mobile object which is a transmission source of task completion information in the mobile object management information, when receiving the task completion information from the mobile object.

9. The information processing apparatus according to claim 7, wherein
when the hardware processor receives delivery task execution request information representing an execution request of a delivery task of delivering a load to a destination from the call execution target mobile object after a start of movement to the specific position,
the hardware processor is configured to:
update, to the delivery task, a task type associated with the mobile object identification information of the call execution target mobile object in the mobile object management information; and
transmit, to the call execution target mobile object, delivery task execution instruction information indicating a delivery instruction of a load from a current position to the destination.

10. The information processing apparatus according to claim 1, wherein
when the hardware processor receives, from the mobile object moving to a destination of a next order, movement request information for avoiding movement to the destination of the next order and for moving to destinations beyond the next order according to sequential delivery task execution instruction information representing a sequential delivery task of delivering loads via a plurality of destinations in order,
the hardware processor is configured to transmit the sequential delivery task execution instruction information indicated by the movement request information to the mobile object.

11. An information processing method executed by an information processing apparatus, the method comprising:
receiving call task execution request information including call task information and a specific position, the call task information indicating a call task in which a mobile object is called to the specific position;
specifying, as a call execution target mobile object of an execution target of the call task, the mobile object identified by mobile object identification information corresponding to task assignment information indicating absence of task assignment in mobile object management information in which the mobile object identification information and the task assignment information are at least associated with each other, when receiving the call task execution request information; and
transmitting, to the call execution target mobile object, call task execution instruction information indicating a movement instruction to the specific position included in the call task execution request information.

12. A computer program product including programmed instructions embodied in and stored on a non-transitory computer readable medium, wherein the instructions, when executed by a computer, cause the computer to perform:
receiving call task execution request information including call task information and a specific position, the call task information indicating a call task in which a mobile object is called to the specific position;
specifying, as a call execution target mobile object of an execution target of the call task, the mobile object identified by mobile object identification information corresponding to task assignment information indicating absence of task assignment in mobile object management information in which the mobile object identification information and the task assignment information are at least associated with each other, when receiving the call task execution request information; and
transmitting, to the call execution target mobile object, call task execution instruction information indicating a movement instruction to the specific position included in the call task execution request information.
